(19) United States
(12) Patent Application Publication
(10) Pub. No.: US 2026/0186546 A1
(43) Pub. Date: Jul. 2, 2026

(54) TIME-BASED POWER SOURCE SWITCHING TO SUPPORT HYBRID POWER BOOST FUNCTIONALITY

(71) Applicant: NVIDIA Corporation, Santa Clara, CA (US)

(72) Inventor: Xiuzhuang Yang, Guangdong (CN)

(21) Appl. No.: 19/005,812

(22) Filed: Dec. 30, 2024

(51) Int. Cl. G06F 1/26

(52) U.S. Cl. CPC G06F 1/263

(57) ABSTRACT

In various examples, a hybrid power boost (HPB) mode of a system (e.g., a computing system or device) may be enabled by continuously and repeatedly cycling through different power sources. For instance, the systems and methods of the present disclosure may apply a pulse width modulation (PWM) signal to one or more components of an electrical circuit that connects the different power sources to the system. During an active state of the PWM signal, a first power source (e.g., an adapter) and a first charge storage component (e.g., capacitor, inductor, etc.) may provide power to the system while a second power source (e.g., a battery) charges a second charge storage component. When the PWM signal switches to an inactive state, the second power source and the second charge storage component may power the system while the first power source recharges the first charge storage component.

### BACKGROUND

Some modern computing systems—such as high-performance laptops—are often tasked with handling complex and resource-intensive activities including, but not limited to, high-end gaming, video editing, and/or 3D rendering. These tasks may demand significant computational power, oftentimes causing a computing system's power requirements to be pushed beyond what its standard power sources are rated to supply. To address these challenges, some manufacturers have introduced hybrid power boost (HPB) techniques, which may allow the computing system to draw power simultaneously from both the battery and the power adapter connected in parallel. As such, these techniques may effectively deliver more power to the system than the adapter or the battery are capable of providing alone.

However, conventional systems that support HPB are often unreliable and may suffer from various inefficiencies. For instance, because voltage levels between different sources connected in parallel should be equal, conventional systems often use a charger—such as a Narrow Voltage Direct Current (NVDC) charger—as a converter to equalize the voltages of the adapter and the battery. However, this process inherently involves energy loss, which may reduce overall system efficiency and/or result in increased heat generation. Additionally, conventional systems may have limitations in accurately controlling power distribution between the adapter and the battery. Consequently, when system loads are high, there may be a risk of overloading the battery or adapter, potentially causing damage to the system or triggering protective mechanisms.

### SUMMARY

Embodiments of the present disclosure relate to time-based power source switching to support hybrid power boost functionality. Systems and methods are disclosed that may alternate between selecting different power sources to enable a hybrid power boost (HPB) mode of a system (e.g., a computing system or device). For instance, the systems and methods of the present disclosure may apply a pulse width modulation (PWM) signal to one or more components of an electrical circuit that connects the different power sources to the system. During an active state of the PWM signal, a first power source (e.g., an adapter) and a first charge storage component (e.g., capacitor, inductor, etc.) may provide power to the system while a second power source (e.g., a battery) charges a second charge storage component. When the PWM signal switches to an inactive state, the second power source and the second charge storage component may power the system while the first power source recharges the first charge storage component.

In contrast to conventional systems, the systems of the present disclosure, in some embodiments, are able to reliably and efficiently support HPB functionality in a wide variety of systems that have multiple power sources. As described in more detail herein, by switching between different power sources at high frequencies, the systems of the present disclosure may better support HPB techniques by avoiding inefficient voltage level conversions. In other words, because the systems in at least some embodiments of the present disclosure switch between different power sources to provide increased power delivery, the voltage levels of the individual power sources may be different since they are not connected in parallel. As such, systems of the present disclosure may conserve energy and reduce heat generation by not having to equalize voltage levels to connect the sources in parallel. Additionally, in contrast to conventional systems, the systems of this disclosure may more easily control power distribution in HPB by controlling the duty cycle of PWM signals, thus making power management designs more flexible. For example, by controlling or changing the duty cycle of the PWM (or other input) signal, the systems of the present disclosure may, among other things, set constraints for adapter and battery max currents, shift system power between the adapter and the battery, and/or exhaust adapter and battery capabilities to get the best system performance.

### BRIEF DESCRIPTION OF THE DRAWINGS

The present systems and methods for time-based power source switching to support hybrid power boost (HPB) functionality are described in detail below with reference to the attached drawing figures, wherein:

FIG. 1 is a data flow diagram illustrating an example of a process for switching between power sources to enable HPB functionality, in accordance with some embodiments of the present disclosure;

FIGS. 2A and 2B illustrate examples of input signals that may be used to switch power sources to enable HPB functionality, in accordance with some embodiments of the present disclosure;

FIGS. 3A and 3B illustrate example current flow directions associated with different power sources during different states of an input signal, in accordance with some embodiments of the present disclosure;

FIG. 4A illustrates an example of a circuit that may be modified to perform power source switching to enable HPB functionality, in accordance with some embodiments of the present disclosure;

FIG. 4B illustrates an example of a modified version of the circuit described in the example of FIG. 4A, in accordance with some embodiments of the present disclosure;

FIG. 4C illustrates another example of a modified version of the circuit described in the example of FIG. 4A, in accordance with some embodiments of the present disclosure;

FIG. 5 illustrates example waveforms corresponding to examples of measured signals, voltages, and currents of a system when switching between power sources to enable HPB functionality, in accordance with some embodiments of the present disclosure;

FIG. 6 is a flow diagram illustrating an example of a method for switching between power sources to enable HPB functionality, in accordance with some embodiments of the present disclosure;

FIG. 7 is a flow diagram illustrating an example of a method for applying a periodic signal to components of an electrical circuit to switch power sources and enable HPB functionality, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Systems and methods are disclosed related to time-based power source switching to support hybrid power boost (HPB) functionality. For instance, based at least on a determination that HPB functionality is to be enabled, a system(s) may cause an input signal (e.g., a periodic signal) to be applied to one or more components of an electrical circuit associated with a machine (e.g., a computing device, laptop, notebook, etc.). The electrical circuit may connect a plurality of different power sources to the machine (e.g., to voltage or power input terminals of the machine), and the power sources may provide power (e.g., voltage and current) to the machine using the electrical circuit. As described herein, based on the input signal being applied to the component(s), the electrical circuit may alternate or switch between which power sources of the plurality are used to power the machine for given periods of time. For instance, one or more first power sources may provide power to the machine during a first state of the input signal, one or more second power sources may power the machine during a second state of the input signal, and so forth. In various examples, the power sources may include passive components that are charged (or recharged) by active components while the power source is disconnected from supplying power to the machine. As such, the passive components may discharge when the power sources are reconnected to supply power to the machine, thereby supplementing the amount of current flowing from the active components/power sources and to the machine, resulting in an increased power level of the machine.

In some examples, the input signal may include a digital or analog periodic signal—such as a square wave, rectangular wave, etc.—that continuously repeats itself after some fixed interval of time or period. For instance, the input signal may include a Pulse Width Modulation (PWM) signal that alternates between active (e.g., on) and inactive (e.g., off) states at some desired frequency. Additionally, or alternatively, the input signal may include a multi-level or discrete-state signal with multiple states, such as a tri-state PWM signal having three states, or any other multi-level signal having any number of states (e.g., 2, 3, 4, etc.). In some instances, the system(s) may vary the frequency of the input signal to achieve a desired power level. For instance, the frequency of the input signal may include 1 kHz, 5 kHz, 10 kHz, 15 kHz, 20 kHz, or any other frequency. In some examples, the system(s) may use one or more General-Purpose Input/Output (GPIO) devices or pins to provide the input signal.

As described herein, the system(s) may use the different states of the input signal to alternate between different power sources of the machine as part of enabling HPB functionality. In other words, the system(s) may use the input signal to provide time-based control of how long each source powers the machine. For instance, by applying the input signal to the component(s) of the electrical circuit, the system(s) may effectively connect and/or disconnect the power sources from supplying power to the machine. In some instances, the component(s) may include semiconductor switches, such as diodes, transistors (e.g., Bipolar Junction Transistors (BJTs), Field-Effect Transistors (FETs), etc.), and/or thyristors, electromechanical switches (e.g., relays), digital logic gates, Microelectromechanical Systems (MEMS) switches, or any other kind of switching components. As such, the component(s) may be disposed along the circuit between the power sources and the machine's voltage terminals, and as the input signal is applied to the component(s), the power sources may be repeatedly connected and disconnected from the machine's voltage terminals at a high frequency.

In various examples, the power sources may include a combination of one or more active components and one or more passive components. For instance, the power sources may include active component(s) such as batteries, adapters (e.g., AC adapters), power supplies, etc. and passive component(s) such as capacitors, inductors, or any other components for storing electrical charge. In even further examples, the power sources may include power adapters as active components and batteries as passive components. In some instances, the power sources of the machine may include components of the same modalities or of different modalities. For instance, the machine may include multiple power sources where the active components for each of the power sources are batteries, adapters, etc.

In some examples, the active and passive components of the power sources may be connected in parallel such that, during an HPB mode of the machine, the active and passive components provide an amount of power to the machine that is greater than the active components could provide alone. By way of example, and not limitation, consider a scenario in which the machine uses or includes a first power source and a second power source, and the first power source includes an adapter, and the second power source includes a battery as their respective active components. For each of these power sources, the adapter may be connected in parallel with a first passive component (e.g., a first capacitor) and the battery may be connected in parallel with a second passive component (e.g., a second capacitor). As such, when the system(s) applies the input signal to enable HPB mode and begin alternating between the two power sources, when the first power source is selected the adapter and the first passive component may supply power (e.g., voltage and current) to the machine while the battery charges the second passive component. Then, when the input signal changes states and the second power source is selected, the battery and the second passive component may supply the power to the machine while the adapter charges the first passive component. In this way, the system(s) may increase the amount of power the individual sources supply to the machine during HPB mode by storing some energy in the passive components while the power sources are not actively powering the machine, and then providing this extra, stored energy to the machine when the power sources are reconnected.

In some examples, the system(s) may determine when to enable the HPB functionality for the machine based on one or more conditions or rules. Take, for example, a machine that includes a battery-based power source and an adapter-based power source. In such an example, the system(s) may determine to not enable HPB functionalities unless the machine is plugged into wall power such that the adapter-based power source is capable of powering the machine. Additionally, or alternatively, the system(s) may not enable HPB functionalities if the battery-based power source is not charged above some threshold. That is, because the HPB functionalities described herein may require at least two power sources, the system(s) may refrain from enabling HPB functionality if only one power source is present or capable of powering the machine. Additionally, in some examples, the system(s) may enable HPB functionalities based on a determination that a power level, power demand, power consumption, etc. of the machine meets or exceeds a threshold. For instance, if the machine is performing resource intensive operations, the power level may meet or exceed the threshold and the system(s) may cause the input signal to be applied to the components of the electric circuit to switch between power sources and enable the HPB functionality.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

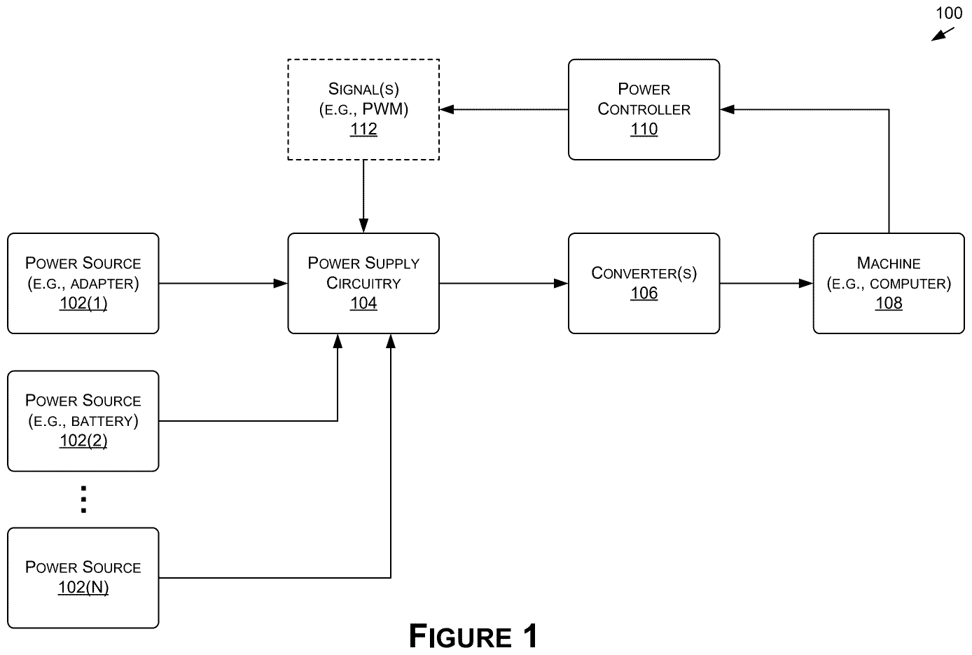

With reference to FIG. 1, FIG. 1 is a data flow diagram illustrating an example of a process 100 for switching between power sources to enable HPB functionality, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As a brief overview of the process 100, a plurality of power sources 102(1)-102(N) (where “N” may represent any number) may be connected, via power supply circuitry 104, to one or more converters 106 of a machine 108, such as a computer. The power sources 102 may provide power (e.g., voltage and current) to the machine 108. The machine 108 may include a power controller 110, and the power controller may apply one or more signals 112 to one or more components of the power supply circuitry 104 to switch between the different power sources 102 during a HPB mode of the machine 108. For instance, the power controller 110 may monitor a power level of the machine 108, and when the power level meets or exceeds a threshold, the power controller 110 may apply the signal(s) 112 to the power supply circuitry 104.

Although illustrated as separate components, the components (e.g., the power source(s) 102, the power supply circuitry 104, the converter(s) 106, and/or the power controller 110) shown in the example of FIG. 1 may be part of, or included in, the machine 108. For instance, the machine 108 may represent or include a laptop or notebook, and the components may be included within or otherwise associated with the laptop/notebook. As such, by performing the techniques disclosed herein, a laptop or notebook may be capable of performing hybrid power boost mode by using time-based switching between power sources and without connecting its power sources in parallel.

In some examples, the signal(s) 112 may include a digital or analog periodic signal—such as a square wave, rectangular wave, etc.—that continuously repeats itself after some fixed interval of time or period. For instance, the signal(s) 112 may include a Pulse Width Modulation (PWM) signal that alternates between high and low (e.g., active and inactive) states at some desired frequency. Additionally, or alternatively, the signal(s) 112 may include a multi-level or discrete-state signal with multiple states, such as a tri-state PWM signal having three states, or any other multi-level signal having any number of states (e.g., 2, 3, 4, etc.). In some instances, the power controller 110 may vary the frequency of the signal(s) 112 to achieve a desired power level. For instance, the frequency of the signal(s) 112 may include 1 kHz, 5 kHz, 10 kHz, 15 kHz, 20 kHz, or any other frequency. In some examples, the power controller 110 may include one or more GPIO pins that are used to provide the signal(s) 112.

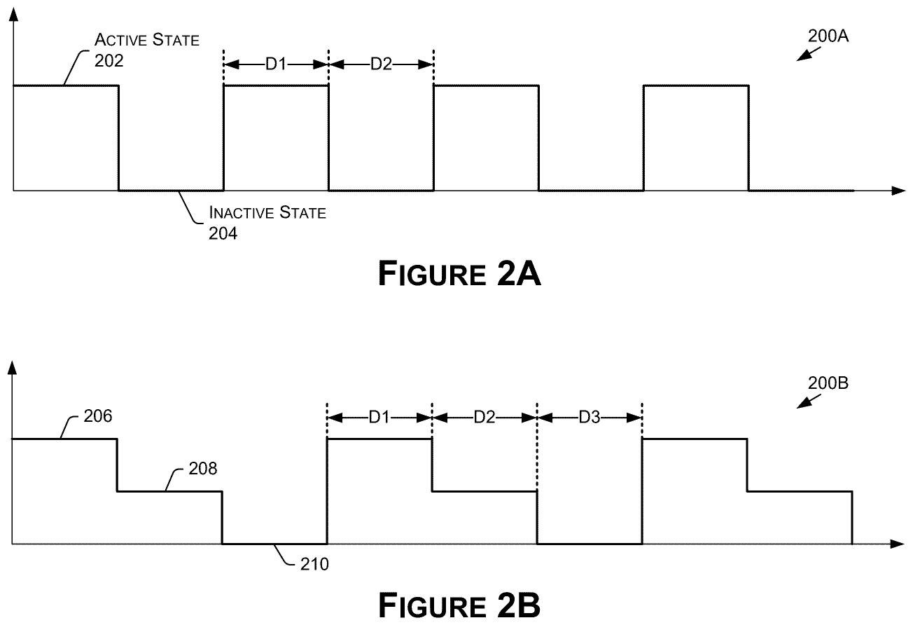

For instance, FIGS. 2A and 2B illustrate examples of input signals that may be used to switch power sources to enable HPB functionality, in accordance with some embodiments of the present disclosure. The first signal 200A illustrated in the example of FIG. 2A may represent a square or rectangular wave signal. For instance, the first signal 200A may include an active state 202 when the first signal 200A is high and an inactive state 204 when the first signal 200A is low. Additionally, D1 may represent the length of the active state 202 and D2 may represent the length of the inactive state 204, and D1+D2 may be equal to the period of the first signal 200A. The second signal 200B illustrated in the example of FIG. 2B may represent a tri-state signal (also referred to as a “multi-level signal”). For instance, the second signal 200B may include a first state 206, a second state 208, and a third state 210. Additionally, D1 may represent the length of the first state 206, D2 may represent the length of the second state 208, D3 may represent the length of the third state 210, and D1+D2+D3 may be equal to the period of the second signal 200B.

Referring back to the example of FIG. 1, the power controller 110 may use the different states of the signal(s) 112 to alternate between the different power sources 102 associated with the machine 108 as part of enabling the HPB functionality. In other words, the power controller 110 may use the signal(s) 112 to provide time-based control of how long each power source 102 powers the machine 108 during HPB mode. For instance, by applying the signal(s) 112 to the component(s) of the power supply circuitry 104, the power controller 110 may effectively connect and/or disconnect individual ones of the power sources 102 from supplying power to the machine 108. In some instances, the component(s) of the power supply circuitry 104 may include semiconductor switches, such as diodes, transistors (e.g., Bipolar Junction Transistors (BJTs), Field-Effect Transistors (FETs), etc.), and/or thyristors, electromechanical switches (e.g., relays), digital logic gates, Microelectromechanical Systems (MEMS) switches, or any other kind of switching components. As such, the component(s) may be disposed along the power supply circuitry 104 between the power sources 102 and the converter(s) 106, and as the signal(s) 112 is applied to the component(s), the power sources 102 may be repeatedly connected and disconnected from the converter(s) 106 at a high frequency. In some examples, the converter(s) 106 may include one or more buck DC-DC converters, one or more boost DC-DC converters, or any other voltage level converters.

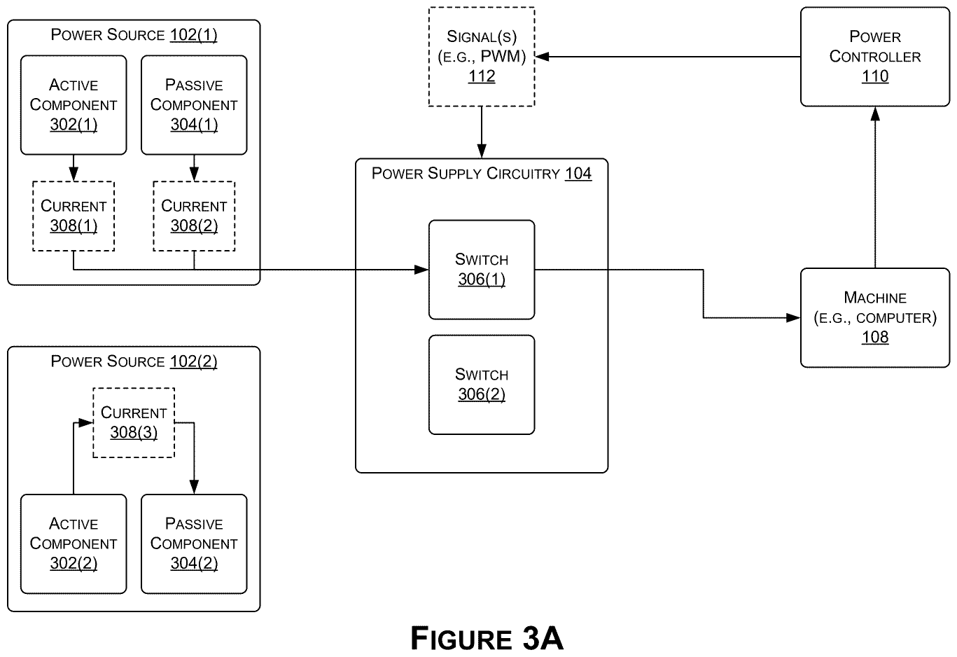

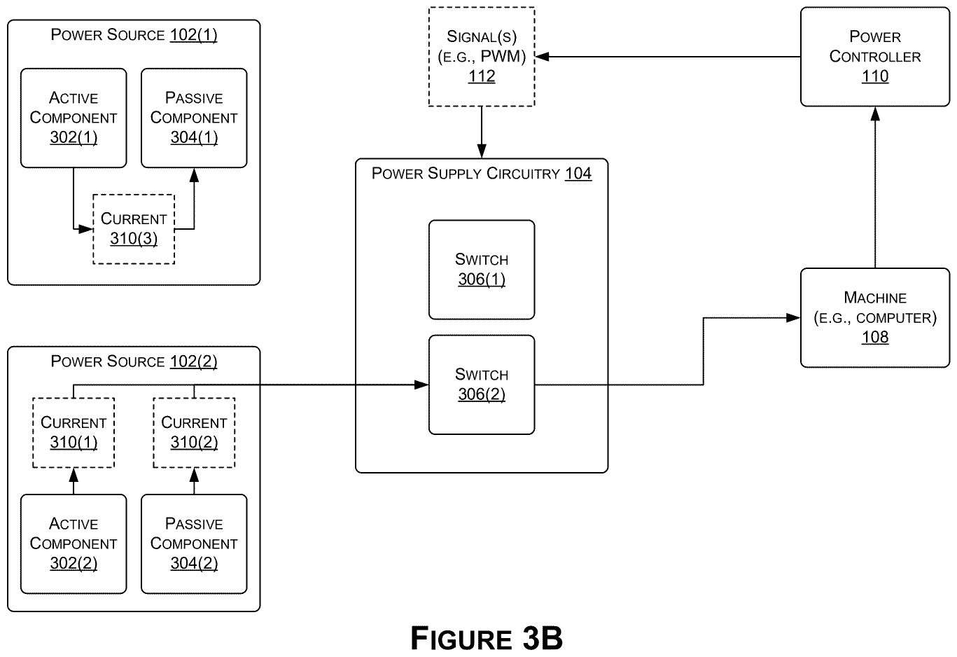

In various examples, the power sources 102 may include a combination of one or more active components and one or more passive components, as described in further detail below in the examples of FIGS. 3A and 3B. For instance, the power sources 102 may include batteries, adapters (e.g., AC adapters), power supplies, capacitors, inductors, or any other components for producing and/or storing electrical charge. In even further examples, the power sources 102 may include power adapters as active components and batteries as passive components. In some instances, the power sources 102 of the machine 108 may include components of the same modalities or of different modalities. For instance, in the example of FIG. 1, the power sources 102 include a first power source 102(1) representing an adapter-based source, a second power source 102(2) representing a battery-based source, and an Nth power source 102(N) (where “N” can equal any number) that could represent, for example, another adapter-based source, another battery-based source, or any other type of source.

In some examples, the active and passive components of the power sources 102 may be connected in parallel such that, during an HPB mode of the machine 108, the active and passive components provide an amount of power to the machine 108 that is greater than the active components could provide alone. For instance, FIGS. 3A and 3B illustrate example current flow directions associated with different power sources during different states of an input signal, in accordance with some embodiments of the present disclosure. As shown, the first power source 102(1) may include a first active component 302(1) and a first passive component 303(1), and the second power source 102(2) may include a second active component 302(2) and a second passive component 304(2). As an example, the first active component 302(1) may include an adapter (e.g., AC adapter output), the first passive component 304(1) may include a first capacitor, the second active component 302(2) may include a battery, and the second passive component 304(2) may include a second capacitor.

In the example of FIG. 3A, the power controller 110 may apply the signal(s) 112 to the power supply circuitry 104. That is, the signal(s) 112 may be applied to a first switch 306(1) and a second switch 306(2) of the power supply circuitry 104. The switches 306 may open and close to disconnect and connect the power sources 102 from the machine 108 based on the signal(s) 112. In the example of FIG. 3A, for instance, the first switch 306(1) may be closed and the second switch 306(2) may be open based on a state associated with the signal(s) 112. With the first switch 306(1) closed, a first amount of current 308(1) may flow out of the first active component 302(1) and a second amount of current 308(2) may flow out of the first passive component 304(1). The first amount of current 308(1) and the second amount of current 308(2) may each flow through the power supply circuitry 104 and into the machine 108. Additionally, based on the second switch 306(2) being open, a third amount of current 308(3) may flow from the second active component 302(2) and into the second passive component 304(2) to charge the second passive component 304(2).

Now referring to the example of FIG. 3B, based on the state of the signal(s) 112 changing from a first state (e.g., active state 202) in the example of FIG. 3A to a second state (e.g., inactive state 204) in the example of FIG. 3B, the first switch 306(1) may be open and the second switch 306(2) may be closed. With the second switch 306(2) closed, a first amount of current 310(1) may flow out of the second active component 302(2) and a second amount of current 310(2) may flow out of the second passive component 304(2). The first amount of current 310(1) and the second amount of current 310(2) may each flow through the power supply circuitry 104 and into the machine 108 while the signal(s) 112 is in he second state. Additionally, based on the first switch 306(1) being open, a third amount of current 310(3) may flow from the first active component 302(1) and into the first passive component 304(1) to charge/recharge the first passive component 304(1).

Referring back to the example of FIG. 1, in some examples, the process 100 may include the power controller 110 determining when to enable the HPB functionality for the machine 108 based on one or more conditions or rules. For example, the power controller 110 may refrain from applying the signal(s) 112 and enabling HPB functionalities if the first power source 102(1) is not capable of generating power (e.g., if the AC adapter is not plugged into wall or line power). Additionally, or alternatively, the power controller 110 may refrain from applying the signal(s) 112 if the battery-based second power source 102(2) is not charged above some threshold (e.g., 60%, 80%, etc.), if the battery has been removed, if the number of recharge cycles associated with the battery exceed a threshold, etc. That is, because the HPB functionalities described herein may require at least two power sources, the power controller 110 may refrain from enabling HPB functionality if only one power source is present or capable of powering the machine 108. Additionally, in some examples, the power controller 110 may enable HPB functionalities based on a determination that a power level of the machine 108 meets or exceeds a threshold. For instance, if the machine 108 is performing resource intensive operations, the power level may meet or exceed the threshold and the power controller 110 may cause the signal(s) 112 to be applied to the components of the power supply circuitry 104 to switch between the power sources 102 and enable the HPB functionality.

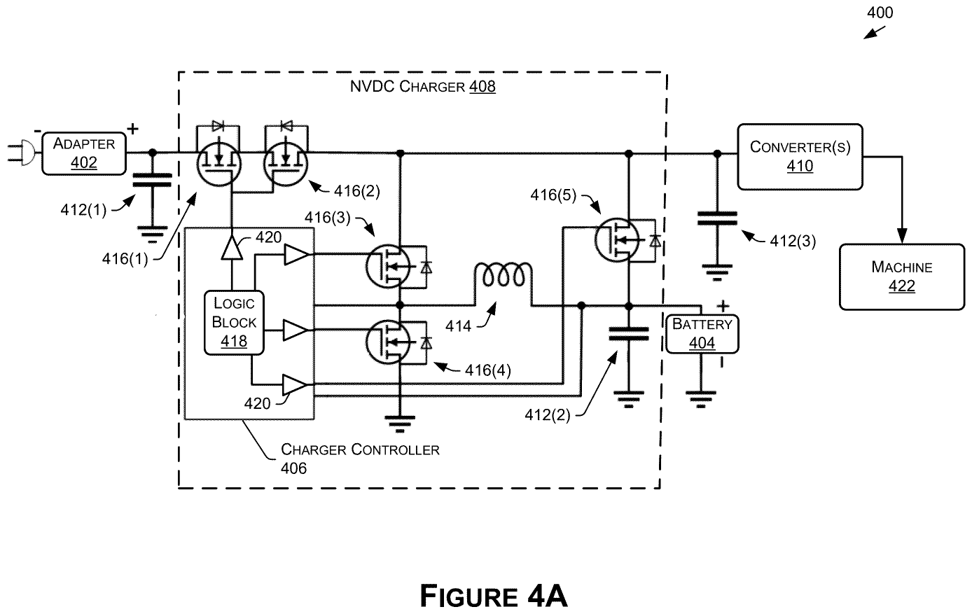

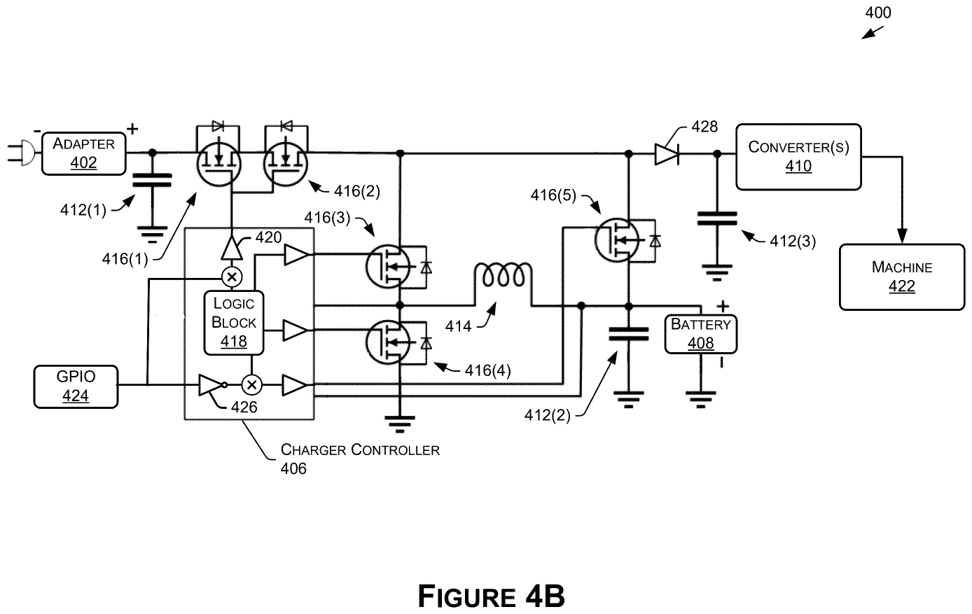

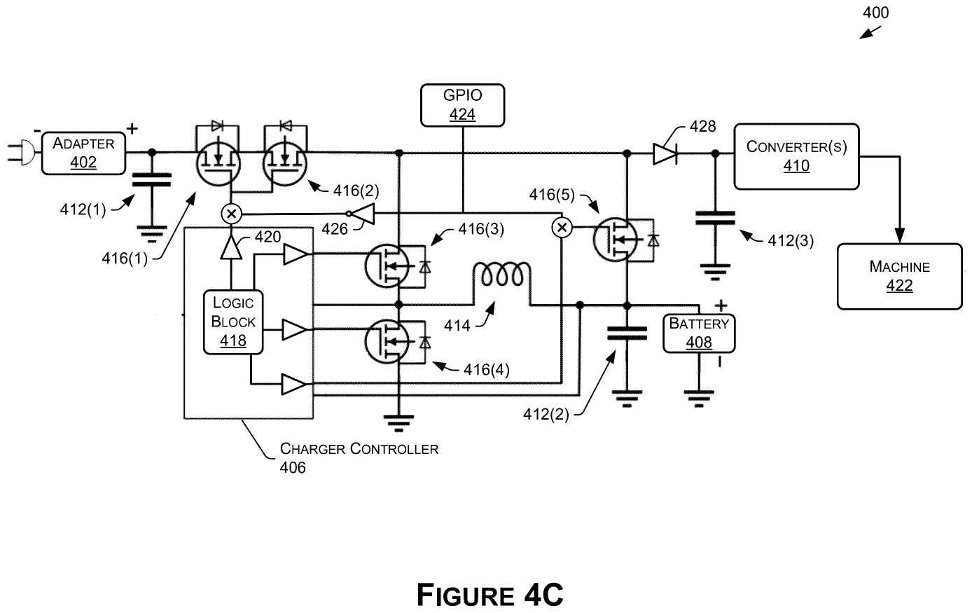

FIG. 4A illustrates an example of a circuit 400 that may be modified to perform power source switching to enable HPB functionality, in accordance with some embodiments of the present disclosure. The circuit 400 may include an adapter 402, a battery 404, a charger controller 406 associated with an NVDC (Narrow Voltage DC) charger 408, one or more converters 410, capacitors 412, an inductor 414, and switches 416 (e.g., Metal Oxide Semiconductor Field Effect Transistors (MOSFETs)). The charger controller 406 may include a logic control block 418 and a plurality of drivers 420 that, under normal operation, drive the switches 416 to, among other things, charge the battery 404 and supply power to the converter(s) 410 and/or the machine 422 using the adapter 402, the battery 404, or both. In some examples, the adapter 402 and the first capacitor 412(1) may correspond to the first power source 102(1) and the battery 404 and the second capacitor 412(2) may correspond to the second power source 102(2) described herein in the examples of FIGS. 1, 3A and 3B.

Now referring to FIG. 4B, FIG. 4B illustrates an example of a modified version of the circuit described in the example of FIG. 4A, in accordance with some embodiments of the present disclosure. For instance, the circuit 400 may be modified as shown in the example of FIG. 4B to enable the techniques described herein for time-based switching between different power sources to enable HPB functionalities. The modified version of the circuit 400 may include a GPIO 424 that applies an input signal (e.g., PWM signal) to the control circuitry of the charger controller 406. For instance the input signal of the GPIO 424 may be applied to the gates of the first switch 416(1), the second switch 416(2), and the fifth switch 416(5) as shown to cause those switches to open and close during the HPB mode of operation. In some examples, the circuit 400 may be modified to include an inverter 426 (e.g., NOT gate) to invert the signal from the GPIO 424. In this way, when the signal is active to close (or open) the first switch 416(1) and the second switch 416(2), the signal may be inactive for the fifth switch 416(5) and its behavior may be opposite that of the first switch 416(1) and the second switch 416(2). Additionally, the circuit 400 may be modified to include a diode 428 to prevent potential reverse flow of current from the converter(s) 410 and/or the machine 422 when the power sources are switched on and off. For instance, because the power sources may not have the exact same voltage levels, the voltage of the node connected to the third capacitor 412(3) may be higher than the voltage of one of the power sources, so when the power sources are switched current may have a tendency to flow in the direction of the lower voltage. As such, the diode 428 may be added to the circuit 400 to prevent such behavior. In the example of FIG. 4B, the GPIO 424 and the logic block 418 may output a high voltage signal (e.g., active signal of PWM) and the signals may be multiplied, then the high voltage may be sent to the driver 420 to drive the first switch 416(1) and the second switch 416(2). Additionally, when the inverter 426 and the logic block 418 output a high voltage signal, the signals may be multiplied and the output high voltage may drive the fifth switch 416(5).

Referring now to FIG. 4C, FIG. 4C illustrates another example of a modified version of the circuit 400 described in the example of FIG. 4A, in accordance with some embodiments of the present disclosure. For instance, the circuit 400 may be modified as shown in the example of FIG. 4C to enable the techniques described herein for time-based switching between different power sources to enable HPB functionalities. The modified version of the circuit 400 in the example of FIG. 4C may include the GPIO 424 that applies the input signal directly to the gates of the first switch 416(1), the second switch 416(2), and the fifth switch 416(5) as shown to cause those switches to open and close during the HPB mode of operation. In some examples, the inverter 426 (e.g., NOT gate) may be used to invert the signal from the GPIO 424. In this way, when the signal is active to close (or open) the first switch 416(1) and the second switch 416(2), the signal may be inactive for the fifth switch 416(5) and its behavior may be opposite that of the first switch 416(1) and the second switch 416(2). Additionally, the circuit 400 may be modified to include the diode 428 to prevent potential reverse flow of current from the converter(s) 410 and/or the machine 422 when the power sources are switched on and off, as described above.

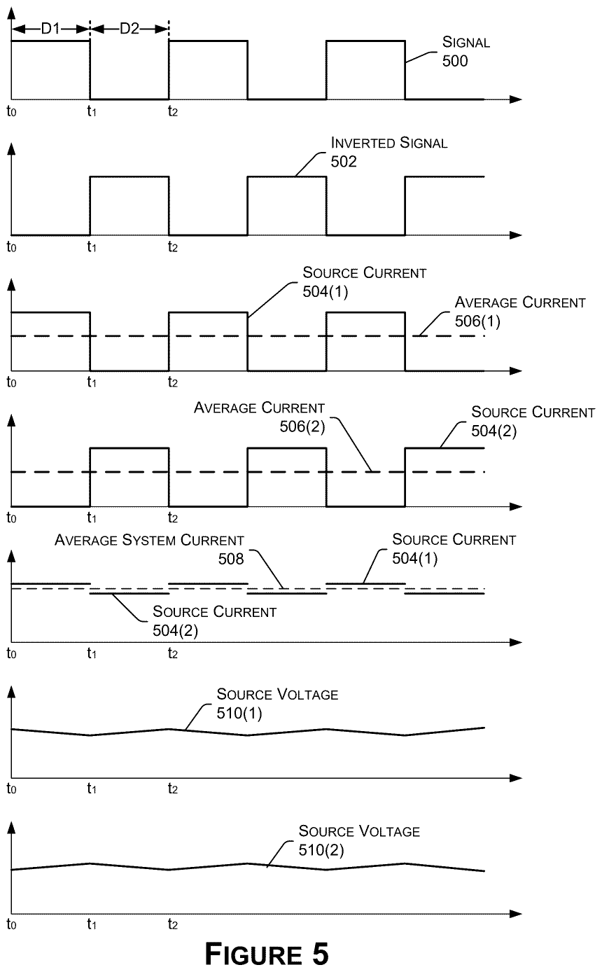

Now referring to FIG. 5, FIG. 5 illustrates example waveforms corresponding to examples of measured signals, voltages, and currents of a system when switching between power sources to enable HPB functionality, in accordance with some embodiments of the present disclosure. Illustrated in FIG. 5 is a signal 500 that may correspond to the signal(s) 112, an inverted signal 502 which may correspond to the signal 500 after being inverted using an inverter, such as the inverter 426 described in the examples of FIGS. 4B and 4C, a first source current 504(1) and first average current 506(1), which may correspond to a source current and average current produced by the first power source 102(1) during HPB mode, a second source current 504(2) and second average current 506(2), which may correspond to a source current and average current produced by the second power source 102(2) during HPB mode, an average system current 508, which may correspond to an average current flowing into the converter(s) 106 and/or the machine 108, an a first source voltage 510(1) and a second source voltage 510(2), which may correspond to measured voltages of the first power source 102(1) and the second power source 102(2), respectively during HPB mode.

In some examples, the first source current 504(1) may correspond to a sum of the first current 308(1) and the second current 308(2) flowing out of the first active component 302(1) and the first passive component 304(1) of the first power source 102(1) illustrated in the example of FIG. 3A. Additionally, the first average current 506(1) may be equal to the sum of those currents multiplied by the duty cycle D1. Similarly, the second source current 504(2) may correspond to a sum of the first current 310(1) and the second current 310(2) flowing out of the second active component 302(2) and the second passive component 304(2) of the second power source 102(2) illustrated in the example of FIG. 3A. Also, the second average current 506(2) may be equal to the sum of those currents multiplied by the duty cycle D2. In some examples, the average system current 508 may be equal to the combined average of the first source current 504(1) and the second source current 504(2).

Based on the example waveforms illustrated in FIG. 5, the power draw from the different power sources of the system in HPB mode may be derived. For instance, because the active components of the power sources 102 may be in parallel with passive components (e.g., capacitors) that may act as a filter, the current draw from the power sources may be a DC current. As such, the power draw from a first source “P_{Source_1}” and the power draw from a second source “P_{Source_2}” during HPB mode may be derived as:

$${P}_{Source \_ 1} = {P}_{System} * D 1 , \qquad ( 1 )$$

$${P}_{Source \_ 2} = {P}_{System} * D 2 , \qquad ( 2 )$$

$$D 2 = 1 - D 1 , \qquad ( 3 )$$

$$D 1 = ( {t}_{1} - {t}_{0} ) / ( {t}_{2} - {t}_{0} ) . \qquad ( 4 )$$

In equations (1) and (2) above, D1 may correspond to the turn on duty cycle of the first source and D2 may correspond to the turn on duty cycle of the second source. From the above equations, the current draw from the first source “I_{Source1}” and the current draw from the second source “I_{Source2}” may be derived as:

$${I}_{Source 1} = {P}_{Source 1} / {V}_{Source 1} = {P}_{System} * D 1 / {V}_{Source 1} , \qquad ( 5 )$$

$${I}_{Source 2} = {P}_{Source 2} / {V}_{Source 2} = {P}_{System} * D 2 / {V}_{Source 2} \qquad ( 6 )$$

where “V_{Source1}” may represent the output or discharge voltage of the first source and “V_{Source2}” may represent the output or discharge voltage of the second source.

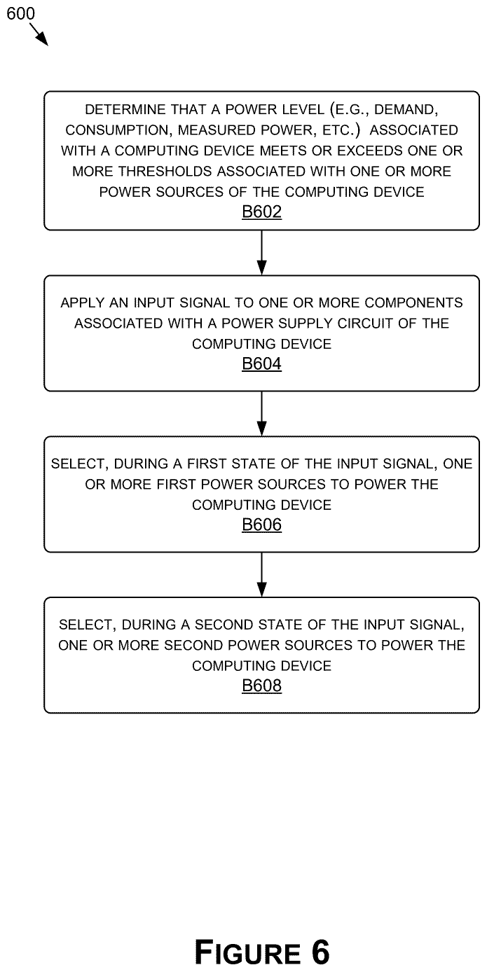

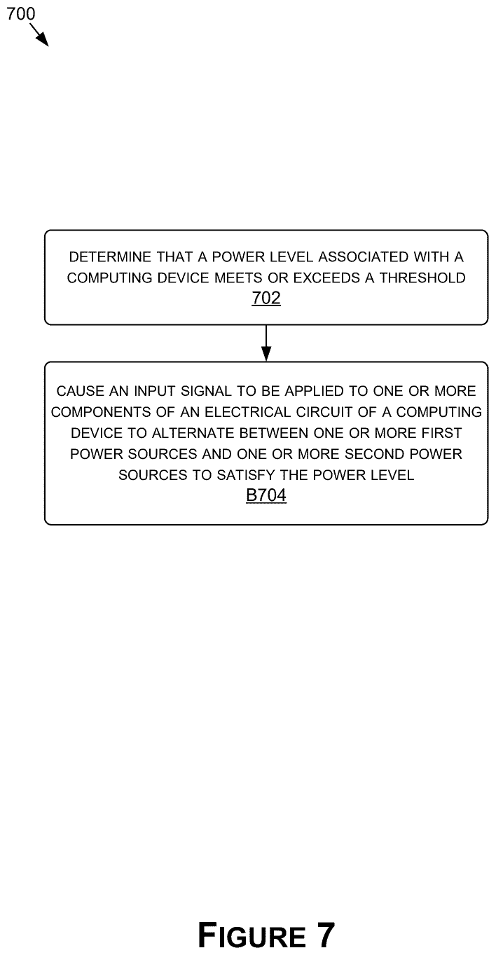

Now referring to FIGS. 6 and 7, each block of methods 600 and 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 600 and 700 are described, by way of example, with respect to the system of FIG. 1. However, this method may additionally or alternatively be executed by any one system, or any combination of systems, including, but not limited to, those described herein.

FIG. 6 is a flow diagram illustrating an example of a method 600 for switching between power sources to enable HPB functionality, in accordance with some embodiments of the present disclosure. The method 600, at block B602, includes determining that a power level associated with a computing device meets or exceeds one or more thresholds associated with one or more power sources of the computing device. For instance, the power controller 110 may determine that the power level associated with the machine 108 meets or exceeds the threshold(s) associated with the power sources 102. In some instances, determining the power level meets or exceeds the threshold(s) may include determining that the computing device is performing operations or otherwise consuming or requiring an amount of power that is greater than an active device (e.g., battery, adapter, etc.) of a power source is capable of outputting alone. In some instances, the power controller 110 may receive an indication from the machine 108 to engage HPB mode. This indication may include, in some examples, an indication of the operations being performed by the machine 108, and the power controller 110 may determine whether those operations will result in an increase in the power level.

The method 600, at block B604, includes applying an input signal to one or more components associated with a power supply circuit of the computing device. For instance, the power controller 110 may apply the signal(s) 112 to the power supply circuitry 104. In some examples, this may include applying the signal(s) 112 to the switches 306 of the power supply circuitry 104.

The method 600, at block B606, includes selecting, during a first state of the input signal, one or more first power sources to power the computing device. For instance, based at least on the power controller 110 applying the signal(s) 112, the first power source 102(1) may power the computing device for a first period of time corresponding to the first state of the signal(s) 112. For instance, during the first state of the input signal, a switch (e.g., transistor) between the first power source(s) and the computing device may close to connect the first power source(s) to the computing device. In some instances, the first power source(s) may include one or more active components or devices (e.g., adapters, batteries, etc.) and one or more passive components or devices (e.g., capacitors, inductors, batteries, etc.).

The method 600, at block B608, includes select, during a second state of the input signal, one or more second power sources to power the computing device. For instance, based at least on the power controller 110 applying the signal(s) 112, the second power source 102(2) may power the computing device for a second period of time corresponding to the second state of the signal(s) 112. For instance, during the second state of the input signal, a switch (e.g., transistor) between the second power source(s) and the computing device may close to connect the second power source(s) to the computing device. In some instances, the second power source(s) may include one or more active components or devices (e.g., adapters, batteries, etc.) and one or more passive components or devices (e.g., capacitors, inductors, batteries, etc.).

FIG. 7 is a flow diagram illustrating an example of a method 700 for applying a periodic signal to components of an electrical circuit to switch power sources and enable HPB functionality, in accordance with some embodiments of the present disclosure. The method 700, at block B702, includes determining that a power level associated with a computing device meets or exceeds a threshold. For instance, the power controller 110 may determine that the power level associated with the machine 108 meets or exceeds the threshold. In some instances, determining the power level meets or exceeds the threshold may include determining that the computing device is performing operations or otherwise consuming or requiring an amount of power that is greater than an active device (e.g., battery, adapter, etc.) of a power source is capable of outputting alone. In some instances, the power controller 110 may receive an indication from the machine 108 to engage HPB mode. This indication may include, in some examples, an indication of the operations being performed by the machine 108, and the power controller 110 may determine whether those operations will result in an increase in the power level.

The method 700, at block B704, includes causing an input signal to be applied to one or more components of an electrical circuit of a computing device to alternate between one or more first power sources and one or more second power sources to satisfy the power level. For instance, the power controller 110 may apply the signal(s) 112 to the component(s) (e.g., switches) of the power supply circuitry 104 to alternate between the first power source 102(1) and the second power source 102(2). As each one of these power sources may include active and passive components, by alternating the power sources the power controller 110 may cause the power sources to increase the amount of power (e.g., current) they supply to the computing device. For instance, during a first state of the signal a first active component (e.g., adapter) and a first passive component (e.g., capacitor) of the first power source may discharge to power the computing device while a second active component (e.g., battery) may charge a second passive component of the second power source. Then, when the signal changes states from the first state to a second state, the second active component and the second passive component may each discharge to power the computing device while the first active component charges/recharges the first passive component.

### Example Computing Device

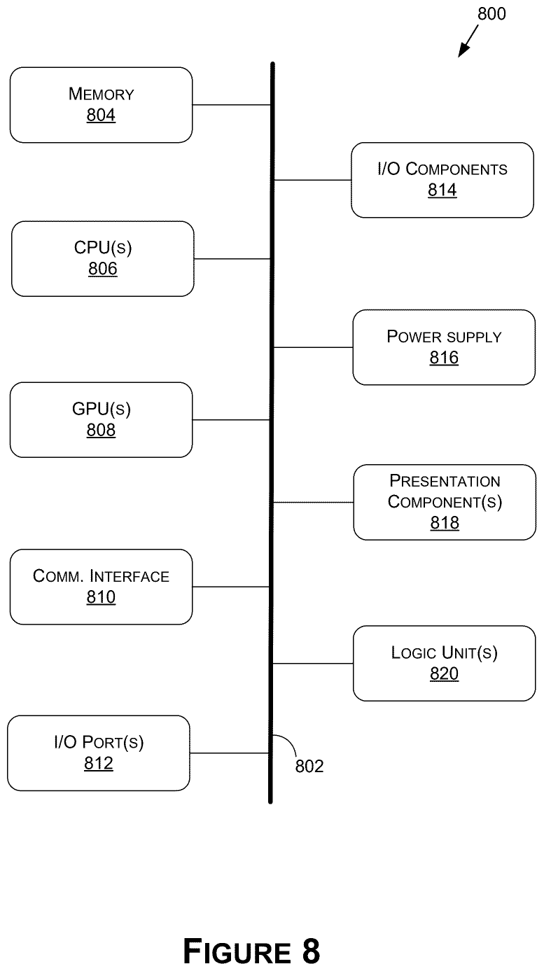

FIG. 8 is a block diagram of an example computing device(s) 800 suitable for use in implementing some embodiments of the present disclosure. In some example, the computing device(s) 800 may correspond to the machine 108. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate. In some examples, the power supply may include one or more of the systems or components described herein for enabling HPB functionality of the computing device 800. For instance, the power supply 816 may include or correspond to the power sources 102.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

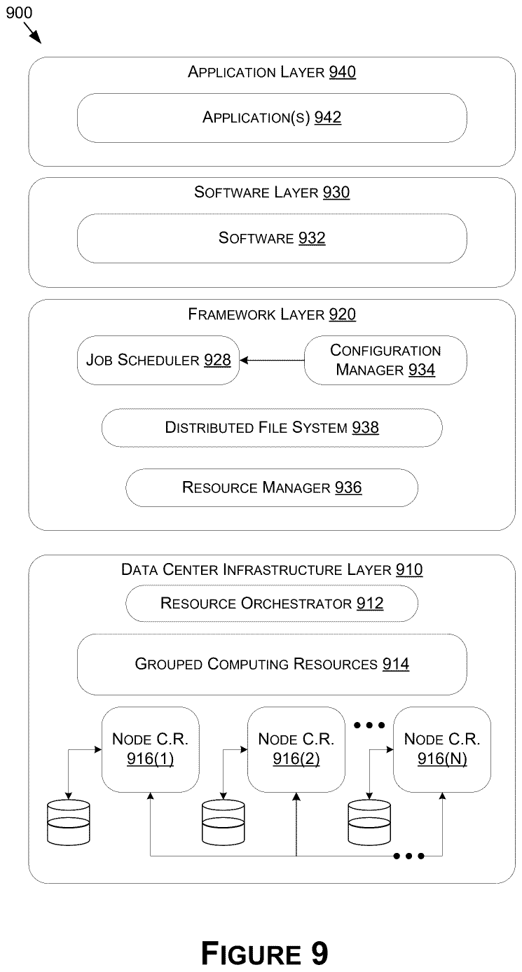

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining that a power level associated with a computing device meets or exceeds one or more thresholds associated with one or more power sources of the computing device; and
based at least on the power level meeting or exceeding the one or more thresholds, applying an input signal to one or more components associated with a power supply circuit of the computing device to cause the power supply circuit to:
select one or more first power sources to provide power to the computing device for one or more first periods of time; and
select one or more second power sources to provide the power to the computing device for one or more second periods of time.

2. The method of claim 1, wherein the input signal further causes the power supply circuit to:
charge one or more first capacitors associated with the one or more first power sources during the second period of time; and
charge one or more second capacitors associated with the one or more second power sources during the first period of time.

3. The method of claim 1, wherein the first period of time corresponds to a first portion of a duty cycle associated with the input signal and the second period of time corresponds to a second portion of the duty cycle associated with the input signal.

4. The method of claim 1, wherein the one or more first power sources include at least a power adapter and a first capacitor, and the one or more second power sources include at least a battery and a second capacitor.

5. The method of claim 1, wherein the one or more components include at least one of:
one or more transistors;
one or more gates;
one or more switches; or
one or more relays.

6. The method of claim 1, wherein the one or more components are included in a controller associated with a charger of the computing device, the charger configured to charge the one or more first power sources using the one or more second power sources.

7. The method of claim 1, wherein the input signal causes the power supply circuit to alternate between selecting the one or more first power sources and the one or more second power sources to supply the power to the computing device based at least on the input signal alternating between a first state during the one or more first periods of time and a second state during the one or more second periods of time.

8. The method of claim 1, wherein the input signal further causes the power supply circuit to select one or more third power sources to supply the power to the computing device for a third period of time.

9. A system comprising:
one or more hardware components to:
cause, based at least on a determination that a power level of a machine meets or exceeds a threshold, an input signal to be applied to one or more components of an electrical circuit to:
select, during one or more first periods of time corresponding to one or more first states of the input signal, one or more first power sources to power the machine; and
select, during one or more second periods of time corresponding to one or more second states of the input signal, one or more second power sources to power the machine.

10. The system of claim 9, wherein a first voltage level of the first power source is different than a second voltage level of the second power source.

11. The system of claim 9, wherein a first amount of current flowing out of the first power source is different than a second amount of current flowing out of the second power source.

12. The system of claim 9, wherein:
the one or more first power sources include one or more first active components and one or more first passive components, and
the one or more second power sources include one or more second active components and one or more second passive components.

13. The system of claim 12, wherein the input signal further causes the one or more components of the electrical circuit to:
charge, during the one or more first periods of time, the one or more second passive components using the one or more second active components; and
charge, during the one or more second periods of time, the one or more first passive components using the one or more first active components.

14. The system of claim 9, wherein the one or more first power sources include at least a power adapter and a first charge storage component, and the one or more second power sources include at least a battery and a second charge storage component.

15. The system of claim 9, wherein the one or more components of the electrical circuit include one or more transistors configured to connect and disconnect the one or more first power sources and the one or more second power sources from powering the machine.

16. The system of claim 9, wherein the input signal further causes the electrical circuit to select, during one or more third periods of time corresponding to one or more third states of the input signal, one or more third power sources to power the machine.

17. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more hardware components comprising:
processing circuitry to cause an input signal to be applied to one or more components of one or more circuits of a computing device to alternate between using one or more first power sources during one or more first states of the input signal and one or more second power sources during one or more second states of the input signal to power the computing device during a hybrid power boost (HPB) mode of the computing device.

19. The one or more hardware components of claim 18, wherein a first voltage level associated with the one or more first power sources is different from a second voltage level associated with the one or more second power sources, the one or more first power sources including at least a first active component connected in parallel with a first passive component, and the one or more second power sources including at least a second active component connected in parallel with a second passive component.

20. The one or more hardware components of claim 18, wherein the one or more hardware components are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
